(19) United States
(12) Patent Application Publication
(10) Pub. No.: US 2006/0215041 A1
(43) Pub. Date: Sep. 28, 2006

(54) Imaging apparatus and image recording method

(76) Inventor: Motoaki Kobayashi, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/376,923

(22) Filed: Mar. 16, 2006

(30) Foreign Application Priority Data
Mar. 25, 2005 (JP) 2005-089513

(51) Int. Cl. H04N 5/222

(52) U.S. Cl. 348/220.1; 348/333.01

(57) ABSTRACT

In an imaging apparatus capable of continuously capturing images, the captured images are displayed sequentially to allow a user to select a desired image and record the selected image on a recording medium. This can prevent the recording of unnecessary images on the recording medium, making effective use of the memory space.

### CROSS-REFERENCE TO RELATED APPLICATION

This application is based upon and claims the benefit of priority from prior Japanese Patent Application No. 2005-089513, filed on Mar. 25, 2005, the entire contents of which are incorporated herein by reference.

### BACKGROUND OF THE INVENTION

1. Field of the Invention

The present invention relates to an imaging apparatus such as a digital camera and an image recording method for the imaging apparatus.

2. Description of the Related Art

An imaging apparatus for forming a subject image on an image-pickup device such as a CCD through an imaging optical system, converting it to an electric signal, and recording a resulting subject image on a recording medium such as a semiconductor memory have recently become widespread.

A camera with a so-called precapture function is proposed in Japanese Patent Laid-Open No. 2002-252804. In this camera, a buffer memory is circularly used to store a predetermined number of the most recently captured images while a user remains pressing a shutter release button at a first (half-press) position, allowing the user to capture images sequentially. Then, when the user further presses the shutter release button to a second (full-press) position, the images stored in the buffer memory before the press of the shutter release button to the second position and an image shot at the time of pressing the shutter release button to the second position are recorded on a recording medium.

The use of this precapture function allows the user to get a desired image easily without missing the opportunity to get the best shot.

In the case of the precapture function proposed in Japanese Patent Laid-Open No. 2002-252804, the images stored in the buffer memory before the press of the shutter release button to the second position and the image shot at the time of the press of the shutter release button to the second position are all recorded on the recording medium. This results in recording even images that do not need recording.

### BRIEF SUMMARY OF THE INVENTION

According to the present invention, there is provided an imaging apparatus capable of continuously capturing images, in which the images continuously captured are displayed sequentially to allow a user to select a desired image and record the selected image on a recording medium. In this case, only the image selected by the user is recorded on the recording medium, and this makes effective use of the memory space possible.

The following is an example of a more detailed structure. An imaging apparatus comprises: an imaging unit for performing an imaging operation to capture a subject image; a recording medium for recording the image captured in the imaging operation performed by the imaging unit; a display part for displaying the image captured in the imaging operation performed with the imaging unit; an imaging instruction part for outputting a first instruction signal when depressed to a first position and a second instruction signal when depressed to a second position; a selection instruction part for outputting a selection instruction signal; and a controller. In the imaging apparatus, the controller controls the imaging unit to repeatedly perform the imaging operation in response to the first instruction signal. Then, when the second instruction signal is output while the imaging operation is repeated, at least images captured before the output of the second instruction signal are displayed sequentially on the display part. Then, when the selection instruction signal is output while the images are sequentially displayed on the display part, an image being displayed on the display part at the time of outputting the selection instruction signal is recorded on the recording medium.

In addition to the above-mentioned recording medium, another recording medium (first recording medium) for temporary storage of images continuously captured by the imaging unit under the control of the controller can also be provided. In this case, another recording medium exists in the imaging apparatus as well as the recording medium (second recording medium) for recording the image being displayed on the display part in response to the selection instruction signal.

When the selection instruction signal is output, the controller can copy the image, being displayed at the time of outputting the election instruction signal, from the first recording medium to the second recording medium so that the image will be recorded on the second recording medium. This allows only the necessary image can be copied from the first recording medium to the second recording medium so that only the necessary image will be recorded on the second recording medium.

For example, the first recording medium can be a hard disk drive. The second recording medium can be a recording medium removably loaded into the imaging apparatus.

The selection instruction part can also output the selection instruction signal in response to the operation of an operation part. Alternatively, it can output the selection instruction signal according to biometric information of an operator (user using this imaging apparatus). The biometric information of the operator can include the brain wave patterns, voice, and eye blinks of the operator.

Further, the controller can display the images captured by the imaging unit on the display part in response to the second instruction signal while extending the display duration of the images irrespective of the actual capturing time of the images. This makes it easy for the user to select an image.

The present invention can also be understood as another example of an imaging apparatus. The imaging apparatus comprises: an imaging part for performing an imaging operation to capture a subject image so as to acquire image data; a display part for displaying the image based on the image data; an operation part manually operated to output a first instruction signal, a second instruction signal, or a third instruction signal; and a controller. In the imaging apparatus, the controller controls the imaging part to acquire image data corresponding to a plurality of images in response to the first instruction signal, displays the plurality of images sequentially on the display part in response to the second instruction signal, and selects image data to be recorded in response to the third instruction signal.

The imaging apparatus can include a first recording medium for temporary storage of the plural pieces of image data and a second recording medium for recording the image data selected.

The imaging apparatus can also include a release button and an operation button. In this case, the release button can be manually operated to output the first instruction signal when depressed to a first position and the second instruction signal when depressed to a second position. The operation button can be manually operated to output the third instruction signal.

In this case, the third instruction signal can be output according to biometric information of an operator (user using the imaging apparatus). The biometric information of the operator can include, for example, the brain wave patterns, voice, and eye blinks of the operator.

The controller can also display the images captured by the imaging part in response to the second instruction signal while extending the display duration of the images irrespective of the actual capturing time of the images. This makes it easy for the user to select an image.

In a more specific structure of the present invention, an imaging apparatus comprises: an image pickup device for capturing a subject image to output an image signal; an image processing controller for processing the image signal to generate image data; a monitor capable of displaying the image data; first, second, and third switches manually operated to output first, second, and third instruction signals, respectively; and a microcomputer. In the imaging apparatus, the microcomputer repeatedly operates the image pickup device and the image processing controller in response to the first instruction signal, displays images captured at least before and at the time of outputting the second instruction signal on the monitor in response to the second instruction signal, and records image data, being displayed at the time of outputting the third instruction signal, on a recording medium in response to the third instruction signal.

On the other hand, the present invention can also be directed to an image recording method.

According to the present invention, only necessary images among all images obtained by a precapture function can be recorded, thereby providing an imaging apparatus and an image recording method for the imaging apparatus capable of effective use of recording medium each having a limited capacity.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a block diagram showing the details of an internal electric circuit configuration of a digital camera as an example of an imaging apparatus according to a first embodiment of the present invention;

FIG. 2 is a back view of the appearance of the digital camera for explaining operation parts of the camera;

FIG. 3 is a flowchart showing the operation of the digital camera in a single-shot mode;

FIG. 4 is a block diagram showing the details of an internal electric circuit configuration of a digital camera as an example of an imaging apparatus according to a second embodiment of the present invention;

FIG. 5 is an illustration showing such a state that the digital camera is connected to an electroencephalographic device as an example of a biometric information input device;

FIG. 6 is an illustration showing such a state that the electroencephalographic device is attached to a user; and

FIG. 7 is a flowchart showing the operation of the digital camera in a single-shot mode according to the second embodiment of the present invention.

### DETAILED DESCRIPTION OF THE PREFERRED EMBODIMENTS

Preferred embodiments of the invention are described below with reference to the accompanying drawings.

### First Embodiment

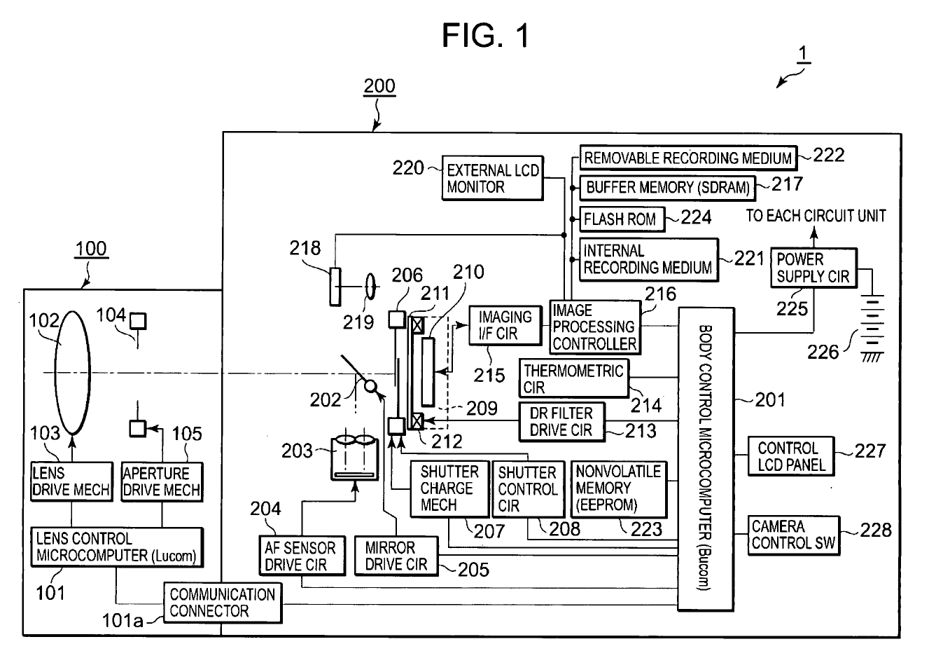

FIG. 1 is a block diagram showing the details of an internal electric circuit configuration of a digital camera as an example of an imaging apparatus according to a first embodiment of the present invention. It is assumed in FIG. 1 that the digital camera (hereinafter called the “camera”) shown in FIG. 1 is a digital single-lens reflex (SLR) camera with interchangeable lenses. However, the first embodiment can be applied to cameras other than the SLR camera.

The camera 1 shown in FIG. 1 has a lens barrel 100 and a camera body 200.

A lens control microcomputer (hereinafter called “Lucom”) 101 controls each component of the lens barrel 100. On the other hand, a body control microcomputer (hereinafter called “Bucom”) 201 controls each component of the camera body 200. When the lens barrel 100 is mounted on the camera body 200, the Lucom 101 and the Bucom 201 are electrically connected through a communication connector 101a so that they can communicate with each other. In this case, the Lucom 101 cooperates dependently with the Bucom 201 to operate in the camera system.

An imaging optical system 102 is provided inside the lens barrel 100. The imaging optical system 102 consists of a plurality of optical lenses, and is driven along its optical axis by a DC motor (not shown) provided in a lens drive mechanism 103.

An aperture 104 is provided behind the imaging optical system 102. The aperture 104 is driven to be opened or closed by a stepping motor (not shown) provided in an aperture drive mechanism 105. The opening/closing of the aperture 104 is controlled to control the amount of light coming from a subject through the imaging optical system 102 and incident into the camera body 200.

Here, the Lucom 101 controls the DC motor in the lens drive mechanism 103 and the stepping motor in the aperture drive mechanism 105 in accordance with instructions from the Bucom 201.

An AF mirror 202 is arranged inside the camera body 200 on the optical path of the imaging optical system 102. When the camera 1 is in a normal state, the AF mirror 202 is at the position shown in FIG. 1. In this case, a flux of light coming from a subject through the imaging optical system 102 is incident on and reflected by the AF mirror 202. The flux of light reflected by the AF mirror 202 is guided to an AF sensor unit 203 for automatic focus adjustment (autofocus (AF) processing). An AF sensor for AF processing, for example, of a phase-contrast type, is provided inside the AF sensor unit 203. The flux of light incident on the AF sensor is converted to an electric signal. The output of the AF sensor in the AF sensor unit 203 is sent to the Bucom 201 through an AF sensor drive circuit 204. The Bucom 201 performs distance measurement processing to calculate a focus state of the imaging optical system 102. The Bucom 201 sends the calculation result to the Lucom 101. Then, based on the focus state notified from the Bucom 201, the Lucom 101 controls the drive of the imaging optical system 102.

When the camera 1 is changed to an imaging mode, the AF mirror 202 is withdrawn out of the optical axis of the imaging optical system 102, and moved to a predetermined position. A mirror drive mechanism 205 drives the AF mirror 202 to move this way. Further, the Bucom 201 controls the mirror drive mechanism 205.

In this case, since the AF mirror 202 is withdrawn out of the optical path of the imaging optical system 102, the flux of light coming from the subject through the imaging optical system 102 is incident on a shutter 206. The shutter 206 is of a focal plane type consisting of front and rear curtains. A shutter charge mechanism 207 charges a spring to drive the front and rear curtains. A shutter control circuit 208 controls the drive of the front and rear curtains. The shutter charge mechanism 207 and the shutter control circuit 208 are controlled by the Bucom 201.

The flux of light passing through the shutter 206 is incident on an image pickup device 210 in an imaging unit 209 arranged behind the shutter 206. The image pickup device 210 is protected by a dust reduction filter 211 provided between the image pickup device 210 and the imaging optical system 102. The dust reduction filter 211 is made of a transparent material such as glass.

Further, a piezoelectric element 212 is attached along the circumference of the dust reduction filter 211 to vibrate the dust reduction filter 211 at a predetermined frequency. The piezoelectric element 212 has two electrodes and is driven by a dust-reduction (DR) filter driving circuit 213. The dust reduction filter 211 is controlled by the Bucom 201. In other words, the DR filter driving circuit 213 drives the piezoelectric element 212 to vibrate the dust reduction filter 211. This allows dust particles adhering on the surface of the dust reduction filter 211 to be shaken off.

Here, the image pickup device 210 and the piezoelectric element 212 are integrally housed in a case with the dust reduction filter 211 as its one side. This construction can ensure the prevention of the dust particles from adhering to the image pickup device 210.

Further, a thermometric circuit 214 is provided near the imaging unit 209. In general, temperature affects the elastic coefficient of a glass material. In other words, since temperature is one factor that varies the natural frequency of the dust reduction filter 211, ambient temperature is always measured for vibrating the dust reduction filter 211. It is preferable that the temperature measuring points of the thermometric circuit 214 be set very close to both poles of the vibrating surface of the dust reduction filter 211. The control of vibration of the dust reduction filter 211 in consideration of temperature variations allows the dust reduction filter 211 to be always vibrated under the optimum conditions.

Here, the camera 1 shown in FIG. 1 uses an electronic view finder (EVF) as its finder. Therefore, an electric signal (picture signal) obtained from the image pickup device 210 is read through an imaging interface (I/F) circuit 215 at every predetermined interval, and converted to a digital signal. Image data obtained from the digital signal from the imaging I/F circuit 215 is stored in a buffer memory 217 such as an SDRAM through an image processing controller 216. The buffer memory 217 is a memory for temporary storage of data such as image data, and is used as a work area for various processing of image data.

The image data read through the imaging I/F circuit 215 and stored in the buffer memory 217 is read by the image processing controller 216. The image data read by the image processing controller 216 is subjected to image processing such as white balance correction for EVF display, and stored in the buffer memory 217. After that, the image data stored in the buffer memory 217 is read by the image processing controller 216 on a frame basis, and converted to a video signal. The video signal is resized to fit a predetermined display size, and displayed on an EVF-LCD monitor 218 as a monitor image so that a user can view the image on the EVF-LCD monitor 218 through an eyepiece 219. This allows the user to observe a subject state through his or her eye even without the provision of an optical finder.

After completion of the imaging operation, the shot image can also be displayed on an external LCD monitor 220. In other words, the image data read from the imaging I/F circuit 215 and stored in the buffer memory 217 is read by the image processing controller 216. The image data read by the image processing controller 216 is subjected to known image processing such as white balance correction, gray-level correction, color correction, etc, and stored in the buffer memory 217. After that, the image data stored in the buffer memory 217 is read by the image processing controller 216, in which the image data is converted to a video signal, resized to fit a predetermined display size, and output to and displayed on the external LCD monitor 220. This allows the user to view the image displayed on the external LCD monitor 220, and hence to check the shot image.

Upon image recording, the image data processed by the image processing controller 216 is compressed by a known compression technique such as JPEG. The JPEG data obtained by applying JPEG compression to the image data is stored in the buffer memory 217, recorded on an internal recording medium 221 as a first recording medium, and then recorded on a removable recording medium 222 as a second recording medium. The internal recording medium 221 is, for example, a hard disk drive. On the other hand, the removable recording medium 222 can be a memory card removably loaded into the camera 1.

Further, upon image playback, the image processing controller 216 reads and decompresses the JPEG data recorded on the internal recording medium 221 or the removable recording medium 222. The decompressed data is converted to a video signal, resized to a predetermined display size, and output to the external LCD monitor 220 so that it will be displayed on the external LCD monitor 220.

A nonvolatile memory 223 storing predetermined control parameters necessary for camera control and a Flash ROM 224 with a camera control program written to it are also connected to the Bucom 201 so that the Bucom 201 can access the control parameters and the camera control program. The nonvolatile memory 223 is, for example, a rewritable EEPROM.

Further, a battery 226 as an electric power source is connected to the Bucom 201 through a power supply circuit 225. The power supply circuit 225 converts the voltage of the battery 226 to a voltage necessary for each component of the camera system, and supplies the voltage to each component of the camera system.

In addition, an LCD panel 227 for showing the operating conditions of the camera 1 so that the user can check the operating conditions of the camera 1 on the display, and camera control switches (SW) 228 for detecting the various operating conditions of the camera 1 are connected to the Bucom 201.

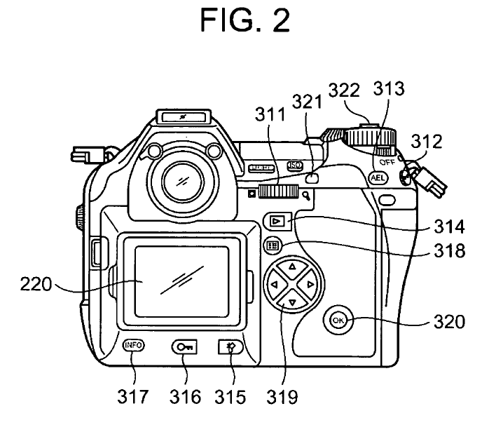

The following describes operation parts of the camera 1. FIG. 2 is a back view of the appearance of the camera 1 for explaining the operation parts of the camera 1. In an actual situation, more operation parts than those shown in FIG. 2 can be arranged on the back face of the camera 1.

As shown in FIG. 2, a main dial 311, an AF frame button 312, an AE lock button 313, a playback mode button 314, an erase button 315, a protect button 316, an information display button 317, a menu button 318, a cross-shaped cursor button 319, an OK button 320, and a bookmark button 321 are provided on the back face of the camera 1. Further, a shutter release button 322 is provided on the top face of the camera 1.

The user operates the main dial 311 while pressing any other operation part. The user can rotate the main dial 311 to change the setting of a function related to the operation part being pressed by the user at the time.

The AF frame button 312 is to select an AF system for imaging. When the user rotates the main dial 311 while pressing this AF frame button 312, the AF system can be changed, for example, to multi AF or spot AF. In the multi AF mode, the focusing states of multiple focusing points on a screen are detected. On the other hand, in the spot AF mode, the focusing state of one point (selectable among multiple points) on the screen is detected.

The AE lock button 313 is to lock exposure. While the user is pressing the AE lock button 313, the amount of exposure calculated at the time is locked.

The playback mode button 314 is to switch the operation mode of the camera 1 to a playback mode capable of playing images back.

The erase button 315 is to erase image data (JPEG file) in the playback mode from the internal recording medium 221 or the removable recording medium 222.

The protect button 316 is to protect image data in the playback mode from being erased by accident.

The information display button 317 is to display additional information embedded in image data based on image information (e.g. Exif information).

The menu button 318 is to display a menu screen on the external LCD monitor 220. The menu screen consists of menu items in a multi-layered structure. The user or operator can select a desired menu item using the cross-shaped cursor button 319 and confirm the selected item by pressing the OK button 320. The menu items include, for example, an imaging menu, a playback menu, a custom menu, and a setup menu. On the imaging menu, the setup of the internal recording medium 221 or the removable recording medium 222, and the settings of image data quality, image processing, and a scene mode can be configured. On the playback menu, playback conditions upon image playback and the setting upon printing of images can be configured. On the custom menu, various detailed settings can be customized according to user's preferences. On the setup menu, the operational conditions of the camera such as the kind of alarm beep sound can be set.

The bookmark button 321 as a selection instruction part is to output a selection instruction signal for selecting an image, from images recorded in a capture operation to be described later, as being copied from the internal recording medium 221 to the removable recording medium 222.

The shutter release button 322 as an imaging instruction part is to perform imaging preparation and exposure operations. The shutter release button consists. of two-step switches, namely a first shutter release switch and a second shutter release switch. When the user presses the shutter release button 322 to a first position, the first shutter release switch works to output a first instruction signal upon which the imaging preparation operations, such as photometering and distance measuring, and the capture operation to be described later are performed. When the user further presses the shutter release button 322 to a second position, the second shutter release switch works to output a second instruction signal upon which images captured at least before and at the time of outputting the second instruction signal are all record on the internal recording medium 221.

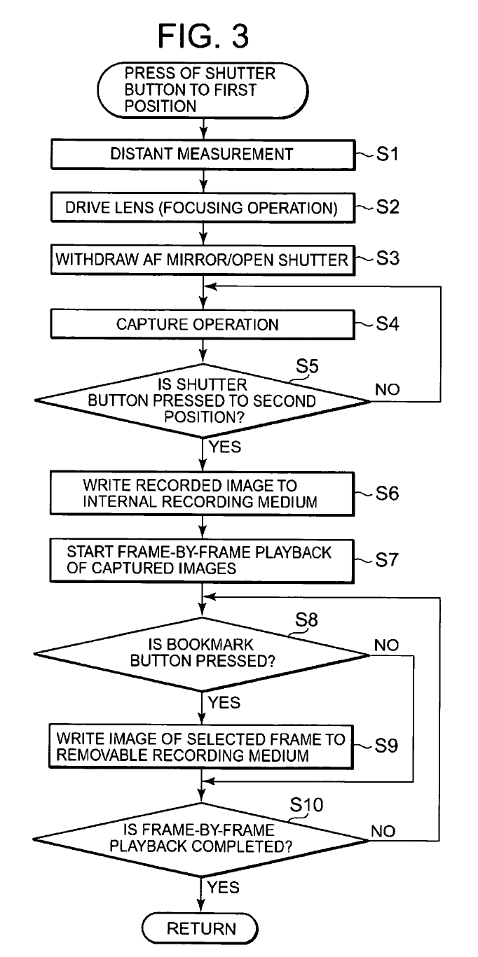

Referring next to the flowchart of FIG. 3, an image recording method performed by the camera 1 having the above-mentioned structure is described. FIG. 3 is a flowchart showing the operation of the camera 1 in a single-shot mode. The flow of FIG. 3 is controlled by the Bucom 201 as a controller.

When the camera 1 is in the single-shot mode, the flow of the flowchart of FIG. 3 is started each time the user presses the shutter release button 322 to the first position. When the user presses the shutter release button 322 to the first position, distance measuring is performed to calculate the focus state of the imaging optical system 102 (step S1). Then, the Lucom 101 calculates the amount of driving the imaging optical system 102 necessary for focus adjustment according to the focus state. Then, based on the calculated amount of drive, the imaging optical system 102 is driven (step S2).

Then, the AF mirror 202 is moved to the predetermined position where it is withdrawn out of the optical path of the imaging optical system 102, and the shutter 206 is opened (step S3). This exposes the imaging surface of the image pickup device 210, enabling the capture operation (step S4). In this capture operation, continuous images are captured. The sequence of images (hereinafter called captured images) obtained in the capture operation are stored one by one in the buffer memory 217. The buffer memory 217 can store a predetermined number of frames (for example, 10 frames) at the maximum. When a new image is captured, if the buffer 217 already contains the predetermined number of image frames, the oldest image is overwritten with the new image in due order. Thus, the predetermined number of frames corresponding to the latest images are stored in the buffer memory 217. If the number of shot images is less than the predetermined number of frames when the capture operation shifts to the following operation (step S6), all the shot images are, of course, stored in the buffer memory 217.

During the capture operation, photometering is performed from cumulatively added values of data in a predetermined range of the image each time one frame is captured. According to the photometering result, the amount of opening of the aperture 104 or the like is adjusted. Alternatively, distance measuring can be performed from cumulatively added values of data in the predetermined range of the image to finely adjust the position of the imaging optical system 102 according to the distance measuring result.

During the capture operation, it is determined whether the user presses the shutter release button 322 to the second position (step S5). As a result of determination in step S5, if the user does not press the shutter release button 322 to the second position, the procedure returns to step S4 to continue the capture operation.

On the other hand, it is determined in step S5 that the user has pressed the shutter release button 322 to the second position, the procedure proceeds from step S5 to step S6, to record, on the internal recording medium 221, the predetermined number of frames corresponding to the latest captured images including the image captured when the user pressed the shutter release button 322 to the second position (step S6). Upon image recording in step S6, the capture operation can be continued for a predetermined period of time after the shutter release button 322 is pressed to the second position so that a predetermined number of frames corresponding to the latest captured images obtained during the period after the shutter release button 322 is pressed to the second position will also be recorded on the internal recording medium 221 as part of the captured images.

After completion of image recording in step S6, the captured images recorded on the internal recording medium 221 are read and played back frame by frame (step S7). Upon playback in step S7, the images are played back frame by frame while extending the display duration of frames irrespective of the actual duration of the frames captured in the capture operation so that the user can have time enough to view the frames and select an image from the frames. Note that the playback of images in step S7 can be done concurrently with the image recording in step S6. In other words, one frame can be read and played back each time one frame is recorded.

Upon image playback, it is determined whether the bookmark button 321 is pressed (step S8). As a result of determination in step S8, if the bookmark button 321 has been pressed, the procedure proceeds from step S8 to step S9, in which the image being displayed on the external LCD monitor 220 when the bookmark button 321 is pressed is copied from the internal recording medium 221 and recorded on the removable recording medium 222 (step S9). Then, the procedure proceeds to step S10. On the other hand, it is determined in step S8 that the bookmark button 321 is not pressed, the procedure proceeds from step S8 to step S10.

Following the above-mentioned processing, it is determined whether the frame-by-frame playback of the captured images is completed, for example, it is determined whether all captured images have been played back (step S10). As a result of determination in step S10, if it is determined that the frame-by-frame playback of the captured images is not completed, the procedure returns to step S8 to continue the frame-by-frame playback. On the other hand, it is determined in step S10 that the frame-by-frame playback of the captured images is completed, the flowchart of FIG. 3 is ended to return to a camera main flowchart, not shown. Note that, after the completion of the frame-by-frame playback of the captured images, the user can be confirmed if the user wants to repeat the frame-by-frame playback.

As described above, according to the first embodiment, since the playback of captured images is performed immediately after completion of imaging in real time, the user can easily select an image to be recorded. This allows the user to select and record the best shot on the removable recording medium easily without fail. Further, since the captured images are recorded on the internal recording medium 221 incorporated in the camera, any one of the captured images can be fetched as necessary later from the internal recording medium 221. In addition, since only the necessary images can be selected and recorded on the removable recording medium, the best shot images can be recorded efficiently without use of a large-capacity recording medium as the removable recording medium.

The flowchart of FIG. 3 shows the operation of the camera 1 in the single-shot mode. When the camera 1 is in a continuous-shot mode, it is determined whether the user has pressed the shutter release button 322 to the second position before shifting from step S6 to step S7. In other words, in the continuous-shot mode, there can be provided a step for repeating the imaging operation and the writing to the recording medium while the user remains pressing the shutter release button at the second position. Then, the procedure can be configured to proceed to step S7 in FIG. 3 when the shutter button is released from the second position. This allows the first embodiment to be applied to the continuous-shot mode of the camera 1.

### Second Embodiment

The following describes a second embodiment of the present invention. The second embodiment of the present invention shows an example in which the user can select an image to be recorded on a removable recording medium according to biometric information from a biometric information input device instead of the bookmark button 321.

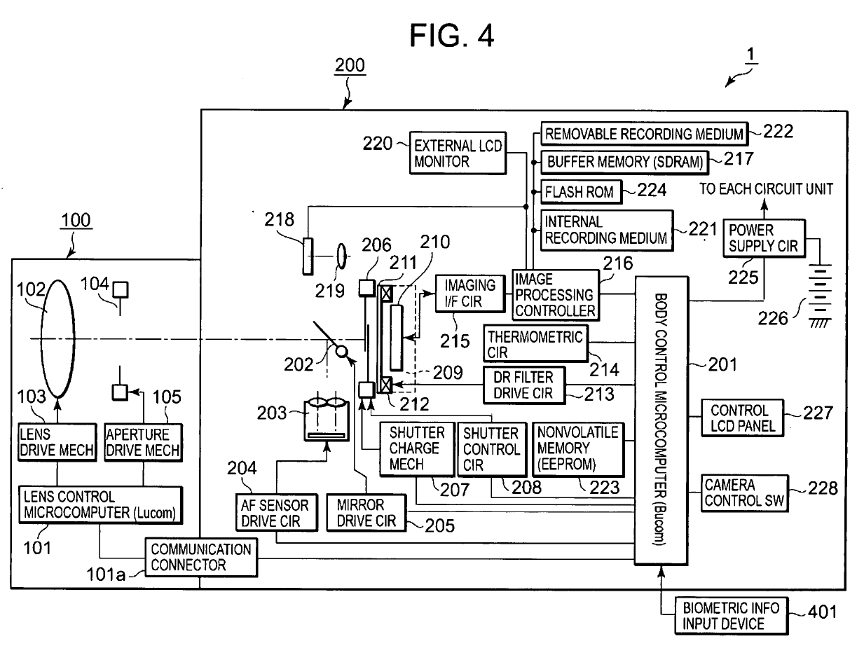

FIG. 4 is a block diagram showing the details of an internal electric circuit configuration of a digital camera as an example of an imaging apparatus according to the second embodiment of the present invention. The structure of the camera 1 itself is the same as that shown in FIG. 1. The camera 1 is connected to a biometric information input device 401 as an external device, so that the biometric information input device 401 works instead of the bookmark button 321 in the first embodiment.

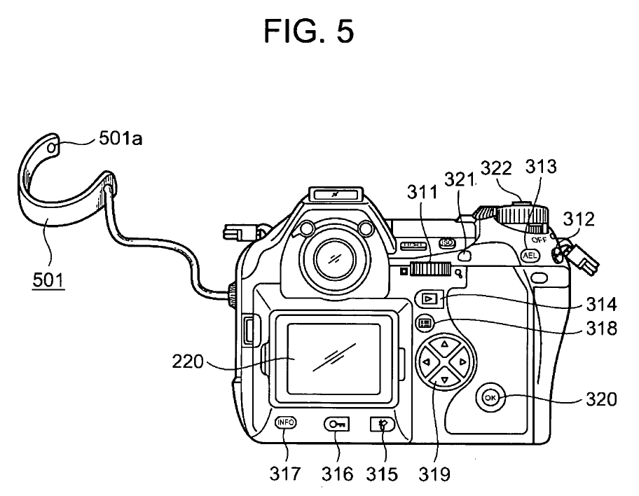

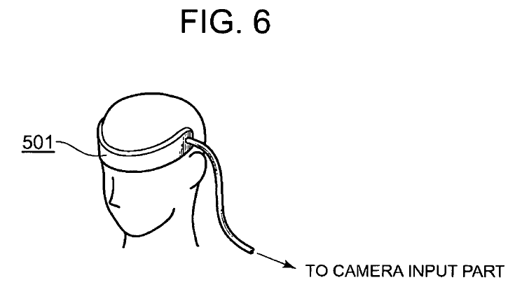

FIG. 5 is an illustration showing such a state that the camera 1 is connected to an electroencephalographic device 501 as an example of the biometric information input device 401. When the user (examinee) attaches the electroencephalographic device 501 to his or her forehead as shown in FIG. 6, the brain wave patterns (including α wave and β wave patterns) of the user are detected through an electrode 501a provided in the electroencephalographic device 501. This signal is input into the Bucom 201 so that the Bucom 201 recognizes the instruction from the user. Note that various devices other than the electroencephalographic device can be considered as the biometric information input device, such as a device for inputting an audio signal and a device for detecting eye blinks or opening/closing of an eyelid of the user.

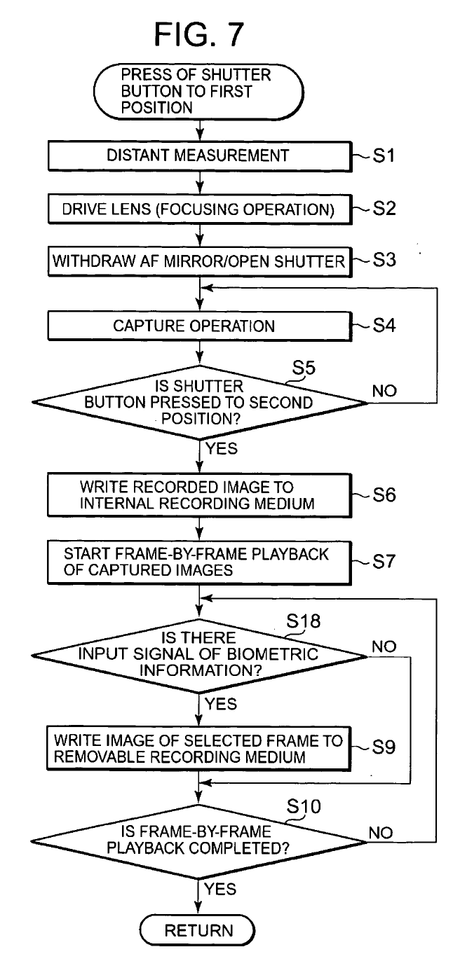

FIG. 7 is a flowchart showing a procedure of an image recording method according to the second embodiment of the present invention. Only a different point is that it is determined whether biometric information is input (step S18) instead of determining in step S8 of FIG. 3 whether the bookmark button 321 is pressed.

As described above, according to the second embodiment, the user can select an image in response to input of the biometric information. This can reduce a delay in response time of a human being from viewing an image until pressing the bookmark button 321.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. An imaging apparatus comprising:
an imaging unit for performing an imaging operation to capture a subject image;
at least one recording medium for recording the image captured in the imaging operation performed by the imaging unit;
a display part for displaying the image captured in the imaging operation performed by the imaging unit;
an imaging instruction part for outputting a first instruction signal when depressed to a first position and a second instruction signal when depressed to a second position;
a selection instruction part for outputting a selection instruction signal; and
a controller for instructing the imaging unit to repeatedly perform the imaging operation in response to the first instruction signal, sequentially displaying at least images captured before the output of the second instruction signal when the second instruction signal is output while the imaging operation is repeated, and recording an image, being displayed on the display part at the time of outputting the selection instruction signal, on the at least one recording medium when the selection instruction signal is output while the images are sequentially displayed on the display part.

2. The apparatus according to claim 1, wherein the at least one recording medium include
a first recording medium for temporary storage of images continuously captured by the imaging unit under the control of the controller, and
a second recording medium for recording an image being displayed on the display part in response to the selection instruction signal.

3. The apparatus according to claim 2, wherein
when the selection instruction signal is output, the controller copies the image, being displayed on the display part at the time of outputting the selection instruction signal, from the first recording medium to the second recording medium so that the image will be recorded on the second recording medium.

4. The apparatus according to claim 2, wherein the first recording medium includes a hard disk drive.

5. The apparatus according to claim 2, wherein the second recording medium includes a recording medium removably loaded into the imaging apparatus.

6. The apparatus according to claim 1, wherein the selection instruction part outputs the selection instruction signal in response to the operation of an operation part.

7. The apparatus according to claim 1, wherein the selection instruction part outputs the selection instruction signal according to biometric information of an operator.

8. The apparatus according to claim 7, wherein the biometric information of the operator includes at least either the brain wave patterns or the voice of the operator.

9. The apparatus according to claim 1, wherein the controller displays the images captured by the imaging unit on the display part in response to the second instruction signal while extending the display duration of the images irrespective of the actual capturing time of the images.

10. An image recording method comprising the steps of:
repeating an imaging operation in response to a first instruction signal;
displaying at least images captured before the output of a second instruction signal when the second instruction signal is output while the imaging operation is repeated; and
recording an image being displayed at the time of outputting a selection signal while the images are displayed sequentially.

11. An image recording method comprising:
recording, on a first recording medium, a sequence of images acquired by repeating an imaging operation in response to a first instruction signal;
sequentially displaying at least images acquired before the output of a second instruction signal when the second instruction signal is output while the images are recorded on the first recording medium; and
copying an image, being displayed at the time of outputting a selection instruction signal, from the first recording medium to a second recording medium, when the selection instruction signal is output while the images are displayed sequentially so that the image will be recorded on the second recording medium.

12. An imaging apparatus comprising:
an imaging part for performing an imaging operation to capture a subject image so as to acquire image data;
a display part for displaying the image based on the image data;
an operation part manually operated to output a first instruction signal, a second instruction signal, or a third instruction signal; and
a controller for controlling the imaging part to acquire image data corresponding to a plurality of images in response to the first instruction signal, displaying the plurality of images sequentially on the display part in response to the second instruction signal, and selecting image data to be recorded in response to the third instruction signal.

13. The apparatus according to claim 12 further comprising:
a first recording medium for temporary storage of the plural pieces of image data, and
a second recording medium for recording the image data selected.

14. The apparatus according to claim 12 further comprising:
a release button operated to output the first instruction signal when depressed to a first position and the second instruction signal when depressed to a second position; and
an operation button manually operated to output the third instruction signal.

15. The apparatus according to claim 12, wherein the third instruction signal is output according to biometric information of an operator.

16. The apparatus according to claim 15, wherein the biometric information of the operator includes at least either the brain wave patterns or the voice of the operator.

17. The apparatus according to claim 12, wherein the controller displays the images captured by the imaging part in response to the second instruction signal while extending the display duration of the images irrespective of the actual imaging time of the images.

18. An imaging apparatus comprising:
an image pickup device for capturing a subject image to output an image signal;
an image processing controller for processing the image signal to generate image data;
a monitor capable of displaying the image data;
a recording medium for storing the image data;
first, second, and third switches for outputting first, second, and third instruction signals, respectively; and
a microcomputer for repeatedly operating the image pickup device and the image processing controller in response to the first instruction signal, displays images, captured at least before and at the time of outputting the second instruction signal, on the monitor in response to the second instruction signal, and records image data, being displayed at the time of outputting the third instruction signal, on the recording medium in response to the third instruction signal.
